(19) United States
(12) Patent Application Publication
(10) Pub. No.: US 2020/0329193 A1
(43) Pub. Date: Oct. 15, 2020

(54) USER INTERFACE AND METHOD FOR A ZOOM FUNCTION

(71) Applicant: IMINT Image Intelligence AB, UPPSALA (SE)

(72) Inventors: Bettina SELIG, Uppsala (SE); Marcus NÄSLUND, Uppsala (SE); Johan SVENSSON, Uppsala (SE); Sebastian BAGINSKI, Enköping (SE)

(73) Assignee: IMINT Image Intelligence AB, UPPSALA (SE)

(21) Appl. No.: 16/304,670

(22) PCT Filed: May 11, 2017
(86) PCT No.: PCT/EP2017/061354

§ 371 Date: Nov. 26, 2018

(30) Foreign Application Priority Data
May 27, 2016 (EP) 16171711.1

(51) Int. Cl. H04N 5/232; G06F 3/0484; G06F 3/0488

(52) U.S. Cl. CPC H04N 5/23216; G06F 3/04842; G06F 2203/04806; H04N 5/23222; H04N 5/23296; G06F 3/0488

(57) ABSTRACT

A user interface, UI, (100) for zooming of a video recording by a device comprising a screen, the UI being configured to: register a marking by a user on the screen of an object in the video recording on the screen, associate the marking with the object, and cause the device to track the marked object, define the tracked object by a first boundary (270), define a second boundary (280), wherein the first boundary is provided within the second boundary, define a third boundary (290) and define a second view of the video recording corresponding to a view of the video recording defined by the third boundary, and change the third boundary such that the third boundary coincides with the second boundary, whereby the second view of the video recording constitutes a zooming of the video recording.

### FIELD OF THE INVENTION

The present invention generally relates to the field of video technology. More specifically, the present invention relates to a user interface for zooming in a video recording.

### BACKGROUND OF THE INVENTION

The recording of videos, especially by the use of handheld devices, is constantly gaining in popularity. It will be appreciated that a majority of today's smartphones are provided with a video recording function, and as the number of smartphone users may be in the vicinity of 3 billion in a few years' time, the market for functions and features related to video recording, especially for devices such as smartphones, is ever-increasing.

The possibility to zoom when recording a video is one example of a function which often is desirable. In case the video is recorded by a device having a touch-sensitive screen, a zoom may often be performed by the user's touch on the screen. However, manual zoom functions of this kind may suffer from several drawbacks, especially when considering that the user may often need to perform the zooming whilst being attentive to the motion of the (moving) object(s). For example, when performing a manual zoom during a video recording session, the user may be distracted by this operation such that he or she loses track of the object(s) and/or that the object(s) move(s) out of the zoomed view. Another problem of performing a manual zoom of this kind is that the user may unintentionally move the device during the zooming, which may result in a video where the one (or more) object is not rendered in a desired way in the video.

Hence, alternative solutions are of interest, which are able to provide a convenient zoom function and/or by which zoom function one or more zoomed objects may be rendered in an appealing and/or convenient way in a video recording.

### SUMMARY OF THE INVENTION

It is an object of the present invention to mitigate the above problems and to provide a convenient zoom function and/or by which zoom function one or more zoomed objects may be rendered in an appealing and/or convenient way in a video recording.

This and other objects are achieved by providing a user interface, a method and a computer program having the features in the independent claims. Preferred embodiments are defined in the dependent claims.

Hence, according to a first aspect of the present invention, there is provided a user interface, UI, for zooming of a video recording by a device comprising a screen. The UI is configured to be used in conjunction with the device, wherein the device is configured to display a first view of the video recording on the screen, and to track at least one object on the screen. The UI is configured to register at least one marking by a user on the screen of at least one object in the on the screen in the displayed first view on the basis of at least one location marked by the user on the screen, whereby the UI is provided with user input. The UI is further configured to associate the at least one marking with the at least one object, and cause the device to track the marked at least one object. The UI is further configured to define the tracked at least one object by at least one first boundary, to define a second boundary, wherein at least one of the at least one first boundary is provided within the second boundary, and to define a third boundary and define a second view of the video recording corresponding to a view of the video recording defined by the third boundary. Furthermore, the UI is configured to change the third boundary such that the third boundary coincides with the second boundary, whereby the second view of the video recording, played in the size of the first view of the video recording, constitutes a zooming of the video recording relative the first view of the video recording.

According to a second aspect of the present invention, there is provided a method for a user interface, UI, for zooming of a first view of a video recording by a device comprising a screen. The UI is configured to be used in conjunction with the device, wherein the device is configured to display the video recording on the screen and to track at least one object on the screen. The method comprises the steps of displaying a first view of the of the video recording. The method further comprises the step of registering at least one marking by a user on the screen of at least one object on the screen in the displayed first view on the basis of at least one location marked by the user on the screen, associating the at least one marking with the at least one object, and causing the device to track the marked at least one object. The method further comprises the steps of defining the tracked at least one object by at least one first boundary, defining a second boundary, wherein at least one of the at least one first boundary is provided within the second boundary, and defining a third boundary and defining a second view of the video recording corresponding to a view of the video recording defined by the third boundary. Furthermore, the method comprises the step of changing the third boundary such that the third boundary coincides with the second boundary, whereby the second view of the video recording, played in the size of the first view of the video recording, constitutes a zooming of the video recording relative the first view of the video recording. According to a third aspect of the present invention, there is provided a computer program comprising computer readable code for causing a computer to carry out the steps of the method according to the second aspect of the present invention when the computer program is carried out on the computer.

Thus, the present invention is based on the idea of providing a user interface, UI, for zooming of a video recording. A user may manually mark one or more objects on the screen of the device, and the UI may thereafter automatically provide an in-zooming and/or out-zooming of the marked object(s). The present invention is advantageous in that the zooming of the object(s) during the video recording by the device is provided automatically by the UI, thereby avoiding drawbacks related to manual zooming. The automatic zoom may conveniently zoom in on (or zoom out of) marked objects, often resulting in a more even, precise and/or smooth zooming of the video recording compared to a manual zooming operation. For example, an attempt of a manual zooming of one or more objects during a video recording may lead to a user losing track of the object(s) and/or that the object(s) move(s) out of the zoomed view. Furthermore, during a manual zooming, the user may unintentionally move the device which may result in a video where the object(s) is (are) not rendered in a desired way in the video recording. The present invention, on the other hand, may overcome one or more of these drawbacks by its automatic zoom function.

It will be appreciated that the UI and the method of the present invention are primarily intended for a real-time zooming of a video recording, wherein the zooming of the video recording is performed during the actual and ongoing video recording. However, the UI and/or method of the present invention may alternatively be configured for a post-processing of the video recording, wherein the system may generate a zooming operation on a previously recorded video.

It will be appreciated that the mentioned advantages of the UI of the first aspect of the present invention also hold for the method according to the second aspect of the present invention.

According to the first aspect of the present invention, there is provided a UI for zooming of a video recording by a device comprising a screen. For example, the UI may be configured to zoom an original view of a video recording. By the term “original view”, it may hereby be meant a full view, a primary (unchanged, unzoomed) view, or the like, of the video recording. By the term “zooming”, it is here meant an in-zooming and/or an out-zooming of the original view of one or more objects.

The UI is configured to be used in conjunction with the device, and the device is configured to display a first view of the video recording on the screen, and to track at least one object on the screen in the displayed first view. By the term “first view”, it may hereby be meant a full view, a primary (unchanged, unzoomed) view, or the like, of the video recording. Hence, the first view may be equal to the original view. Alternatively, the first view may be defined by the original view of the video recording, i.e. the first view may be equal or smaller than the original view. Hence, the “first view” may be found within the original view, and may hereby constitute a sub-view of the original view. For example, the first view may constitute a cropped view of the original view. By the term “track”, it is here meant an automatic following of the marked object(s).

The UI is configured to register at least one marking by a user on the screen of at least one object on the screen in the displayed first view on the basis of at least one location marked by the user on the screen, whereby the UI is provided with user input. By the term “marking”, it is here meant indicating, selecting and/or registering an object on the screen.

The UI is further configured to associate the at least one marking with the at least one object, and cause the device to track the marked at least one object. By the term “associate”, it is here meant to couple, link and/or connect the marking(s) with the object(s). The UI is further configured to define the tracked at least one object by at least one first boundary. Hence, each tracked object may be defined by a first boundary, i.e. each tracked object may be provided within a first boundary. The first boundary may also be referred to as a “tracker boundary”, or the like. The UI is further configured to define a second boundary, wherein at least one of the at least one first boundary is provided within the second boundary. In other words, one or more of the first boundaries may be enclosed by a second boundary. The second boundary may also be referred to as a “target boundary”, or the like.

The UI is further configured to define a third boundary and define a second view of the video recording corresponding to a view of the video recording defined by the third boundary. In other words, the second view corresponds to the resulting view of the video recording, i.e. the view of the video recording when the video recording is (re)played. The third boundary may also be referred to as a “zoom boundary”, or the like.

Furthermore, the UI is configured to change the third boundary such that the third boundary coincides with the second boundary, whereby the second view of the video recording, played in the size of the first view of the video recording, constitutes a zooming of the video recording relative the first view of the video recording. Alternatively, in case the first view is defined by an original view, the second view of the video recording, played in the size of the original view of the video recording, constitutes a zooming of the video recording relative the original view of the video recording. Hence, the third boundary is automatically moved, changed, shifted, increased, decreased and/or resized such that it coincides with the second boundary. Furthermore, as the second view corresponds to a view of the video recording defined by the third boundary, the move, change and/or resizing of the third boundary implies an in-zooming or out-zooming of the video recording relative the first view (or original view) of the video recording.

According to an embodiment of the present invention, the user interface may further be configured to stabilize at least one of the first view and the second view of the video recording. By “stabilize”, it is here meant that the device may be configured to keep the first view and/or the second view of the video recording relatively stable, i.e. relatively free of movements, shakings, etc. The present embodiment is advantageous in that the UI may define a view of the video recording which is stabilized by the device, resulting in a display of the video recording on the screen which may be relatively stable.

According to an embodiment of the present invention, the at least one first boundary may be provided within the second boundary, and the second boundary may be provided within the third boundary. The user interface may further be configured to decrease the size of the third boundary such that the third boundary coincides with the second boundary, whereby the second view of the video recording, played in the size of the first view of the video recording, constitutes an in-zooming of the video recording relative the first view of the video recording.

According to an embodiment of the present invention, the user interface may be configured to display, on the screen, at least one of the at least one first boundary, the second boundary and the third boundary. The present embodiment is advantageous in that a user may see the conditions of the zooming operation of the UI, and, optionally, change one or more of the conditions. For example, if the UI is configured to display the one or more first boundary, a user may see which objects have been marked and tracked. Furthermore, if the UI is configured to display the second boundary, a user may see which boundary the UI intends to zoom towards by the third boundary. Furthermore, if the UI is configured to display the third boundary, a user may see how the zooming by the third boundary towards the second boundary may render the second view (i.e. the zoomed view) of the video recording.

According to an embodiment of the present invention, the user interface may be configured to display on the screen, at least one indication of a center portion of at least one of the at least one first boundary, the second boundary and the third boundary. The present embodiment is advantageous in that the center portion indication(s) may facilitate the user's conception of the center(s) of the boundary or boundaries, and consequently, the conception of the resulting video recording.

According to an embodiment of the present invention, the user interface may be a touch-sensitive user interface. By the term “touch-sensitive user interface”, it is here meant a UI which is able to receive an input by a user's touch, such as by one or more fingers of a user touching the UI. The present embodiment is advantageous in that a user, in an easy and convenient manner, may mark, indicate and/or select an object by touch, e.g. by the use of one or more fingers.

According to an embodiment of the present invention, the marking by a user on the screen of at least one object may comprise at least one tapping by the user on the screen on the at least one object. By the term “tapping”, it is here meant a relatively fast pressing of one or more fingers on the screen. The present embodiment is advantageous in that a user may conveniently mark an object being visually present on the screen.

According to an embodiment of the present invention, the marking by a user on the screen of the at least one object may comprise an at least partially encircling marking of the at least one object on the screen. By the term “an at least partially encircling marking”, it is here meant a circular or at least a circle-like marking of the user around one or more objects on the screen. The present embodiment is advantageous in that it a user may intuitively and conveniently mark an object on the screen.

According to an embodiment of the present invention, the user interface further comprises a user input function configured to associate at least one user input with at least one object on the screen, wherein the user input is selected from a group consisting of eye movement, face movement, hand movement and voice, and wherein the user interface is configured to register at least one marking by a user of at least one object based on the user input function. In other words, the user input may comprise one or more eye movements, face movements (e.g. facial expression, grimace, etc.), hand movements (e.g. a gesture) and/or voice (e.g. voice command) by a user, and the user input function may hereby associate the user input with one or more objects on the screen. The present embodiment is advantageous in that the user interface is relatively versatile related to the selection of object(s), leading to a UI which is even more user-friendly.

According to an embodiment of the present invention, the user input function is an eye-tracking function configured to associate at least one eye movement of a user with at least one object on the screen, and wherein the user interface is configured to select at least one object based on the eye-tracking function. The present embodiment is advantageous in that the eye-tracking function even further contributes to the efficiency and/or convenience of the operation of the UI related to the selection of one or more objects.

According to an embodiment of the present invention, the user interface may be configured to register an unmarking by a user on the screen of at least one of the at least one object. By the term “unmarking”, it is here meant a deletion, removal and/or deselection of one or more objects. The present embodiment is advantageous in that it a user may unmark any object(s) which the user no longer wants the video recording to zoom into.

According to an embodiment of the present invention, the user interface may be configured to, in case there is no marked at least one object, increase the size of the third boundary such that the third boundary coincides with the first view, whereby the second view of the video recording, played in the size of the first view of the video recording, constitutes an out-zooming of the video recording relative the second view of the video recording corresponding to a view of the video recording defined by the third boundary of decreased size relative the first view of the video recording. In other words, if the user unmarks the (or all) object(s), the size of the third boundary increases. As the second view of the video recording corresponds to a view of the video recording defined by the third boundary, the second view constitutes an out-zooming of the video recording. The present embodiment is advantageous in that the user may decide to interrupt the zooming and return to the (unzoomed) view of the video recording.

According to an embodiment of the present invention, the user interface may be configured to register at least one gesture by a user on the screen, and to associate the at least one gesture with a change of the second boundary. The user interface may furthermore be configured to display, on the screen, the change of the second boundary. By the term “gesture”, it is here meant a movement, a touch, a pattern created by the touch of at least one finger top, or the like, by the user on a touch-sensitive screen of a device. The present embodiment is advantageous in that the second boundary may be changed in an easy and intuitive manner. Furthermore, as the UI is configured to display the change (i.e. the move, re(sizing), or the like) of the second boundary, the user is provided with feedback from the change.

According to an embodiment of the present invention, the user interface may be configured to associate the at least one gesture with a change of size of the second boundary. In other words, the user may make the second boundary smaller or larger by a gesture registered on the screen. For example, the gesture may be a “pinch” gesture, whereby two or more fingers are brought towards each other.

According to an embodiment of the present invention, the user interface may further be configured to register a plurality of input points by a user on the screen, and scale the size of the second boundary based on the plurality of input points. By the term “input points”, it is here meant one or more touches, indications, or the like, by the user on the touch-sensitive screen. The present embodiment is advantageous in that the second boundary may be changed in an easy and intuitive manner.

According to an embodiment of the present invention, the user interface may further be configured to associate the at least one gesture with a re-positioning of the second boundary on the screen.

According to an embodiment of the present invention, the user interface may further be configured to register the at least one gesture as a scroll gesture by a user on the screen. By the term “scroll gesture”, it is here meant a gesture of a “drag-and-drop” type, or the like.

According to an embodiment of the present invention, the user interface may further be configured to estimate a degree of probability that the tracked at least one object is moving out of the first view of the video recording. In case the degree of probability exceeds a predetermined probability threshold value, the user interface may be configured to generate at least one indicator for a user, and alert the user by the at least one indicator. The present embodiment is advantageous in that the UI may alert a user during a video recording that the object(s) that are tracked on the screen are moving out of the first view of the video recording, such that the user may move and/or turn the video recording device to be able to continue to record the objects.

According to an embodiment of the present invention, the user interface may be configured to estimate the degree of probability based on an at least one of a location, an estimated velocity and an estimated direction of movement of the at least one object. The present embodiment is advantageous in that the inputs of location, velocity and/or estimated direction of movement of the object(s) may further improve the estimate of the degree of probability that object(s) are about to move out of the first view of the video recording.

According to an embodiment of the present invention, the user interface may further be configured to, in case the degree of probability exceeds the predetermined probability threshold value, display at least one visual indicator on the screen as a function of at least one of the location, the estimated velocity and the estimated direction of movement of the at least one object. The present embodiment is advantageous in that the user may be conveniently guided by the visual indicator(s) on the screen to move and/or turn the video recording device if necessary.

According to an embodiment of the present invention, the at least one visual indicator comprises at least one arrow.

According to an embodiment of the present invention, the device is configured to generate a tactile alert, and in case the degree of probability exceeds the predetermined probability threshold value, cause the device to a generate a tactile alert. By the term “tactile alert”, it is here meant e.g. a vibrating alert.

According to an embodiment of the present invention, the device is configured to generate an auditory alert, and in case the degree of probability exceeds the predetermined probability threshold value, cause the device to generate an auditory alert. By the term “auditory alert”, it is here meant e.g. a signal, an alarm, or the like.

According to an embodiment of the present invention, the user interface is configured to display, on a peripheral portion of the screen, the second view of the video recording. By the term “peripheral portion”, it is here meant a portion at an edge portion of the screen. The present embodiment is advantageous in that the user may be able to see the second view of the video recording, which constitutes a zooming of the video recording relative the first view of the video recording, at the peripheral portion of the screen. According to an embodiment of the present invention, the user interface is further configured to change the speed of the zooming. The present embodiment is advantageous in that the video recording may be rendered in an even more dynamic manner. For example, the user interface may be configured to have a relatively high speed of the zooming for a livelier video experience. Conversely, the user interface may be configured to have a relatively low and/or moderate speed of the zooming for a calmer experience.

According to an embodiment of the present invention, there is provided a device for video recording, comprising a screen and a user interface according to any one of the preceding claims.

According to an embodiment of the present invention, there is provided a mobile device comprising a device for video recording, wherein the screen of the device is a touch-sensitive screen.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a and 1b are schematic views of a first view of the user interface (UI), wherein a user may mark an object, according to an exemplifying embodiment of the present invention,

FIGS. 2a and 2b are schematic views of the zoom function of the UI, according to an exemplifying embodiment of the present invention,

FIGS. 3a and 3b are schematic views of the UI being configured to register an unmarking of an object by a user on the screen, according to an exemplifying embodiment of the present invention,

FIGS. 4a and 4b are schematic views of a UI being configured to adjust the zooming of an object, according to an exemplifying embodiment of the present invention,

FIGS. 5a-5c are schematic views of a UI being configured to change the position of the second boundary, according to an exemplifying embodiment of the present invention,

FIGS. 6a-6c are schematic views of a UI being configured to change the size of the second boundary, according to an exemplifying embodiment of the present invention,

FIG. 7 is a schematic view of a UI being configured to generate an alert, according to an exemplifying embodiment of the present invention,

FIG. 8 is a schematic view of a mobile device for video recording, according to an exemplifying embodiment of the present invention, and

FIG. 9 is a flow chart of the method according to the second aspect of the present invention.

### DETAILED DESCRIPTION

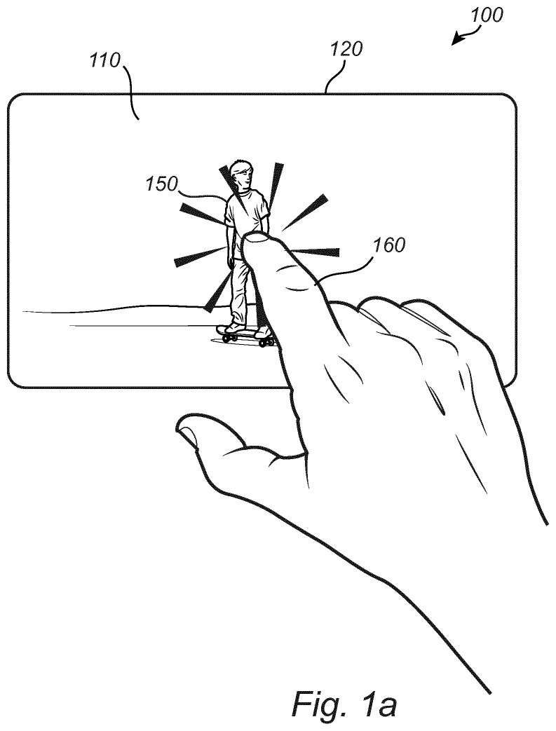

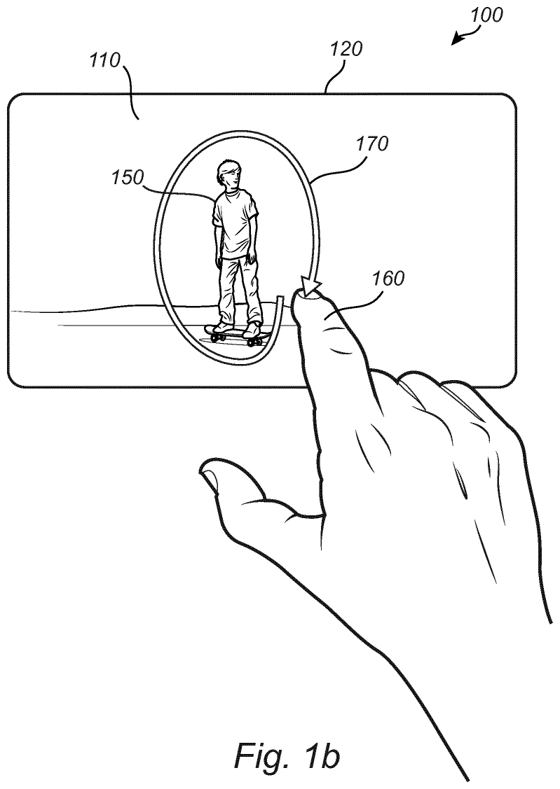

FIGS. 1a and 1b are schematic views of a user interface 100, UI, for zooming of a video recording by a device comprising a screen 120. The device is configured to display a first view 110 of the video recording on the screen 120. It will be appreciated that the device may be substantially any device comprising a video recording function, e.g. a smartphone. The zooming of the video recording may be started by a user who marks an object 150 present on the screen 120 in the first view 110, whereby the UI 100 is configured to register this marking and to associate the marking with the object 150. In FIG. 1a, the marking of the object 150 comprises a tapping on the screen 120 by a finger 160 of the user. Alternatively, and as shown in FIG. 1b, the marking of the object 150 may comprise an at least partially encircling marking 170 of the object 150 on the screen. For example, the user may hold down a finger 160 and draw or indicate a circle around the object 150. By these marking(s) of one or more objects 150 in the video recording on the screen, the UI 100 is provided with user input. If there is more than one object, the UI 100 may be configured to register a plurality of objects 150. Although not indicated, the UI 100 may further comprise a user input function configured to associate at least one user input (e.g. eye movement, face movement, hand movement, voice, etc.) with one or more objects 150 on the screen, and wherein the UI 100 is configured to register the marking by a user of one or more objects 150 based on the user input function. For example, the user input function may be an eye-tracking function configured to associate at least one eye movement of a user with one or more objects 150 on the screen, and wherein the UI 100 is configured to register the marked object(s) 150 based on the eye-tracking function. As yet another example, a user may provide user input by his/her voice, in terms of a voice command. For example, by the voice command “child”, “house”, “animal”, etc., the user input function may be configured to associate the voice command with a child, house, animal, respectively, on the screen, and the UI 100 may hereby be configured to register this marking by the user of one or more of these object(s) 150.

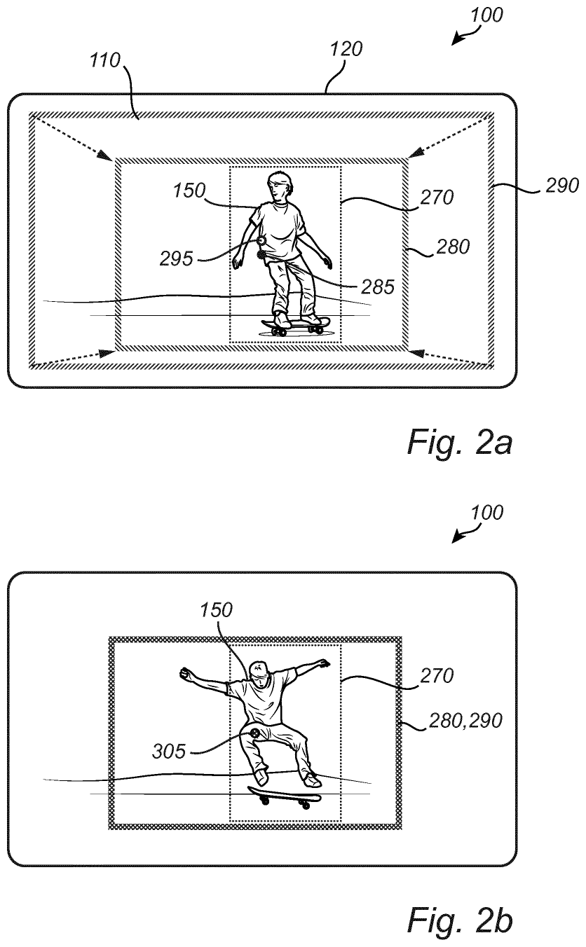

FIGS. 2a and 2b are schematic views of the zoom function of the UI 100. The UI 100 has registered an object 150 on the screen, e.g. by the user input as described in FIG. 1a and FIG. 1b, and causes the device to track the marked object 150. It will be appreciated that the tracking function is known by the skilled person, and is not described in more detail. The UI 100 is configured to define the tracked object 150 by at least one first boundary 270, i.e. the object 150 is enclosed by the first boundary 270. Here, the first boundary 270 is exemplified as a rectangle which encloses (defines) the object 150. It will be appreciated that there may be more than one object 150 on the screen, and hence, there may be a plurality of first boundaries 270, each defining an object 150.

The UI 100 is further configured to define a second boundary 280, wherein one or more of the first boundary(ies) 270 is provided within the second boundary 280. Hence, if there is more than one first boundary 270, some or all of these first boundaries 270 may be enclosed by the second boundary 280. For example, a user may manually select at least one first boundary 270 to be provided within the second boundary 280. The center portion of the second boundary 280 is indicated by a marker 285. In one embodiment of the UI 100, the second boundary 280 is displayed on the screen.

The UI 100 is further configured to define a third boundary 290, provided within the first view 110 or original view of the video recording, and to define a second view of the video recording corresponding to a view of the video recording defined by the third boundary 290. In other words, it is the second view of the video recording which may constitute the resulting video recording. The center portion of the third boundary 290 is indicated by a marker 295.

Furthermore, the UI 100 is configured to automatically change and/or move the third boundary 290, as indicated by the schematic arrows at the corners of the third boundary 290, such that the third boundary 290 coincides with (i.e. adjusts to) the second boundary 280. In FIG. 2a, the second boundary 280 is provided within the third boundary 290, and the size of the third boundary 290 is decreased such that the third boundary 290 coincides with the second boundary 280.

The UI 100 may be configured to stabilize the first view 110 and/or second view of the video recording. It will be appreciated that a stabilizing function of this kind is known by the skilled person, and is not described in more detail.

In FIG. 2b, the third boundary 290 has been automatically moved (decreased) such that it coincides with the second boundary 280. Accordingly, the marker 285 of the center portion of the second boundary 280 and the marker 295 of the center portion of the third boundary 290 of FIG. 2a have coincided, and the center portion of the third boundary 290 coinciding with the second boundary 280 is indicated by a marker 305. It will be appreciated that the second view corresponds to the view of the video recording defined by the third boundary 290, and in FIG. 2b, the second view of the video recording, played in the size of the first view of the video recording, hereby constitutes a zooming of the video recording relative the first view of the video recording. In other words, as the third boundary 290 is smaller than the first view, the second view results in a zooming of the video recording relative the first view.

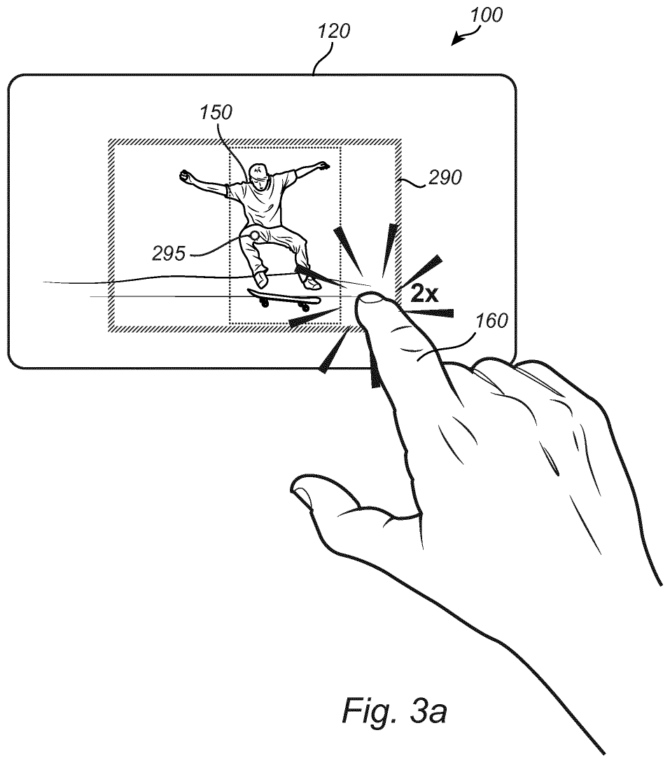

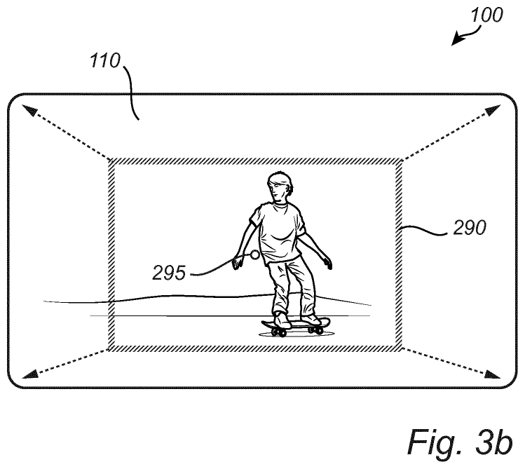

FIG. 3a is a schematic view of a UI 100 being configured to register an unmarking by a user on the screen 120 of one or more objects 150. Here, the unmarking of the object 150 comprises a double tapping on the screen 120 by a finger 160 of the user. In case there is at least one marked object 150 remaining after the unmarking operation, the UI 100 is configured to (re)define a second boundary, wherein the second boundary encloses all remaining (i.e. marked) objects 150. Furthermore, in case the unmarking of the user leads to the situation where there is no marked object 150, the size of the third boundary 290 is increased such that the third boundary 290 coincides with the first view, as shown in FIG. 3b. Consequently, the second view of the video recording, played in the size of the first view of the video recording, constitutes an out-zooming of the video recording relative the second view of the video recording, when the second view corresponds to a view of the video recording defined by the third boundary 290 of decreased size relative the first view of the video recording. Analogously with the exemplifying embodiment of FIG. 2a, the UI 100 may be configured to stabilize the first view 110 and/or the second view of the video recording.

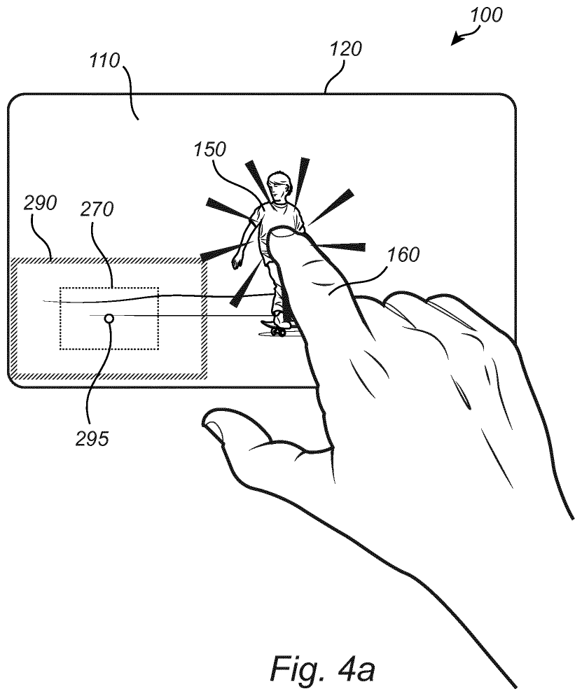

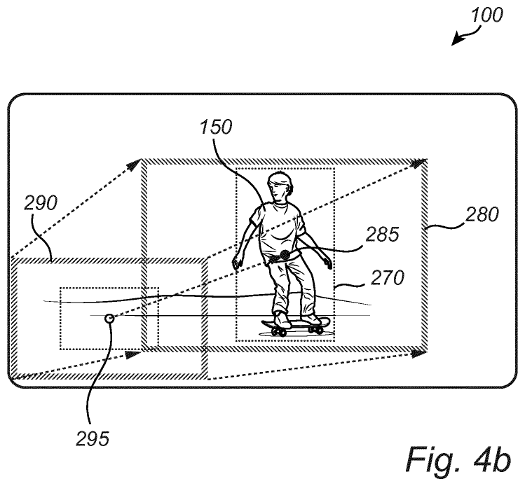

FIGS. 4a-b are schematic views of a UI 100 being configured to adjust the zooming of a video recording. In FIG. 4a, an object 150 in the first view 110 is outside the first boundary 270, and also outside the third boundary 290. Here, the UI 100 may register a marking by a user on the screen of the object 150 in the first view 110 of the video recording on the screen, e.g. by a (single) tapping by a finger 160 of a user. In accordance with previously described operations, the UI 100 may be configured to associate the marking with the object 150, and cause the device to track the marked object 150. As shown in FIG. 4b, the UI 100 is configured to (re)define the tracked object 150 by a first boundary 270, to define a second boundary 280 which encloses (defines) the first boundary 270 and to change, move and/or resize the third boundary 290 such that the third boundary 290 coincides with the second boundary 280. This change, move and/or resizing of the third boundary 290 is schematically indicated by the arrows in FIG. 4b. Accordingly, the marker 285 of the center portion of the second boundary 280 and the marker 295 of the center portion of the third boundary 290 will coincide upon moving (changing/resizing) the third boundary 290.

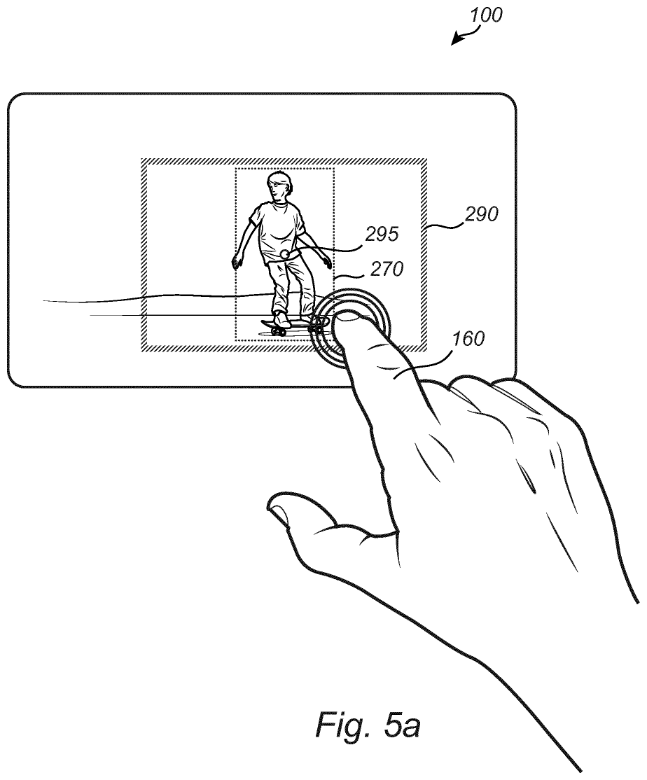

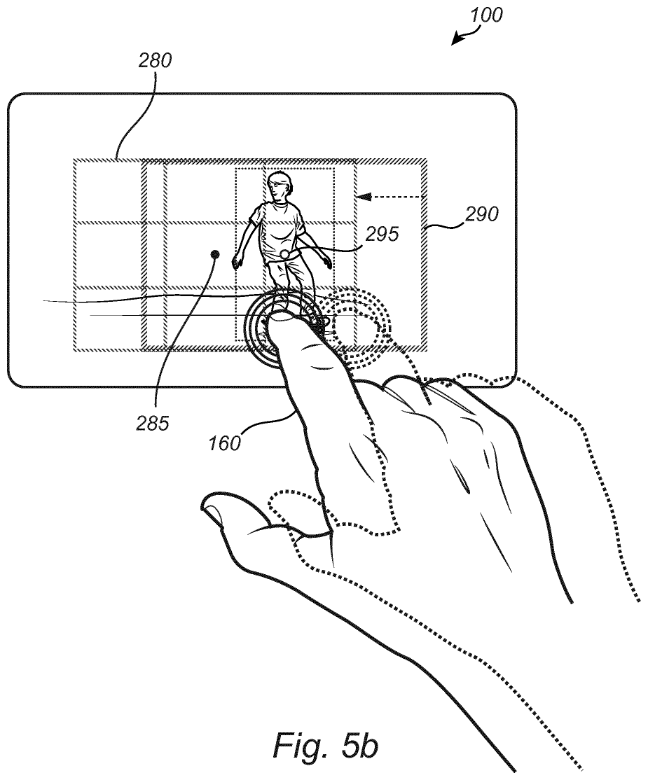

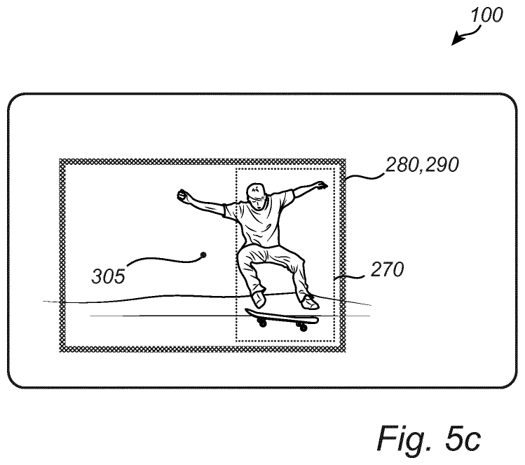

FIGS. 5a-c are schematic views of a UI 100 being configured to change the position of the second boundary 280. In FIG. 5a, the UI 100 is configured to register a gesture by a user on the screen. In FIGS. 5a-5b, the gesture is exemplified as a scroll gesture, a “drag-and-drop” gesture, or the like. The UI 100 is configured to register a touch by a finger 160 of the user on the screen (FIG. 5a) and to register a movement of the finger 160 on the screen to the left (FIG. 5b). During the movement of the finger 160 on the screen, the UI 100 is configured to move the second boundary 280 accordingly, and optionally, to display the movement of the second boundary 280 on the screen. It will be appreciated that a display of the second boundary 280 as sub-frames is purely optional. In FIG. 5c, the third boundary 290 has been changed (moved), such that the third boundary 290 coincides with the second boundary 280. Furthermore, the markers 285 and 295 of FIG. 5b have coincided into the marker 305 of FIG. 5c. The resulting second view of the video recording, played in the size of the first view of the video recording, constitutes a zooming of the video recording relative the first view of the video recording, whereby the object 150 is positioned in a right hand side portion of the third boundary 290. The shift of the third boundary 290 is indicated by the marker 305 of the center portion of the third boundary 290, as the object 150 is found to the right of the marker 305. The shift of the third boundary 290 may furthermore be indicated by optionally displaying the first boundary 270, which is found at a right hand side portion of the third boundary 290. In other words, in this embodiment of the present invention, the user may manually shift the center of the resulting second view of the video recording. Furthermore, a user may improve the experience of a recorded sequence by the operations in FIGS. 5a-5c, e.g. by using the so called “rule of thirds” when shifting the center of the second view.

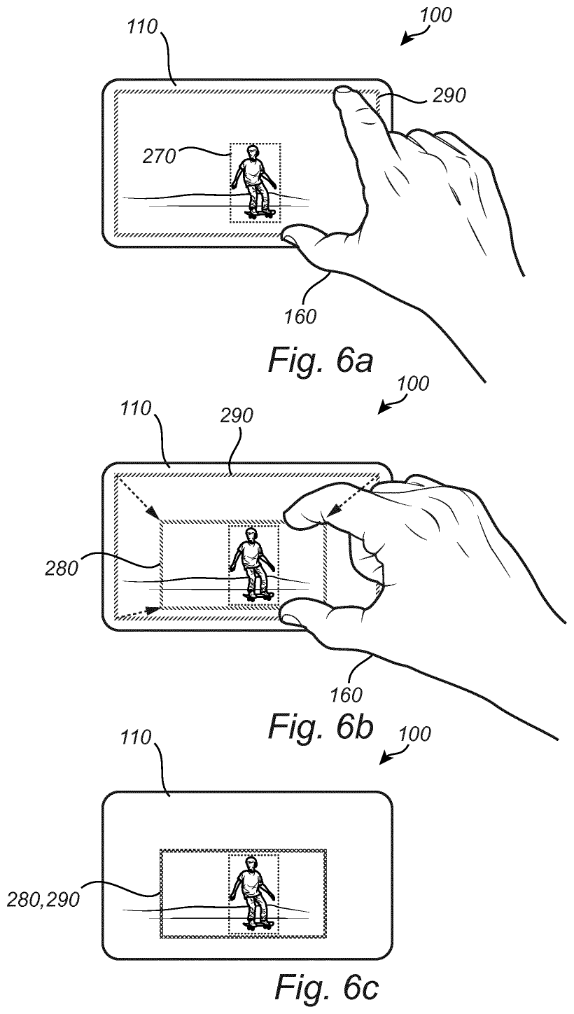

FIGS. 6a-c are schematic views of a UI 100 being configured to change the size of the second boundary 280. In FIGS. 6a-6b, the UI 100 is configured to register at least one location of a plurality of input points (e.g. by two fingers 160 of a user) on the screen, and register at least one movement of at least one of the plurality of input points by a user on the screen. This operation may furthermore be referred to as a pinch gesture by two or more fingers 160 of a user on the screen. In FIG. 6b, the UI 100 is configured to register the pinch gesture described above as a decrease of size of the second boundary 280, and the UI 100 may hereby scale the size of the second boundary 280 based on the at least one location and the at least one movement of the plurality of input points provided by the user. In FIG. 6c, the third boundary 290 has been decreased in size compared to the size of the third boundary 290 in FIG. 6b. In other words, the resulting second view of FIG. 6c of the video recording, played in the size of the first view of the video recording, constitutes a zoomed video recording. It will be appreciated that the change of size of the second boundary 280 by the user may, analogously, constitute an enlargement of the second boundary 280 such that a resulting second view of the video recording constitutes a “less” zoomed video recording relative the zooming showed in FIG. 6b.

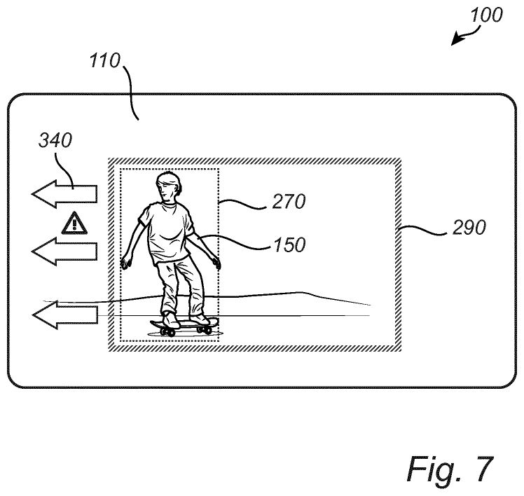

FIG. 7 is a schematic view of a UI 100 being configured to generate an alert for a user that an object 150 may be about to leave the first view 110 of the video recording. Firstly, the UI 100 is configured to estimate a degree of probability that the tracked object 150, defined by the first boundary 270, is moving out of the first view 110 of the video recording. Here, the second view of the video recording, i.e. the zooming of the video recording relative the first view of the video recording, corresponds to a view of the video recording defined by the third boundary 290. It will be appreciated that the probability may be based on at least one of a location, an estimated velocity and an estimated direction of movement of the object 150. In case the degree of probability exceeds a predetermined probability threshold value, the UI 100 may be configured to generate at least one indicator for a user, and alert the user by the at least one indicator. In FIG. 7, there is provided an example of this alert/alarm function, wherein an object 150 is moving relatively quickly to the left in the first view 110. As the UI 100 may estimate and/or predict that the object 150 is about to leave the first view 110 at a left hand side portion of the first view 110, based on the object's location, velocity and/or direction of movement, the UI 100 is configured to display three arrows 340 as visual indicators on a left hand side portion of the screen such that a user may be informed that he or she should turn the video recording device for a continuous video recording of the object. It will be appreciated that the UI 100 furthermore may generate an auditory and/or audial alert (e.g. an alarm) and/or a tactile alert (e.g. a vibration) if the object 150 is about to leave the first view 110 of the video recording.

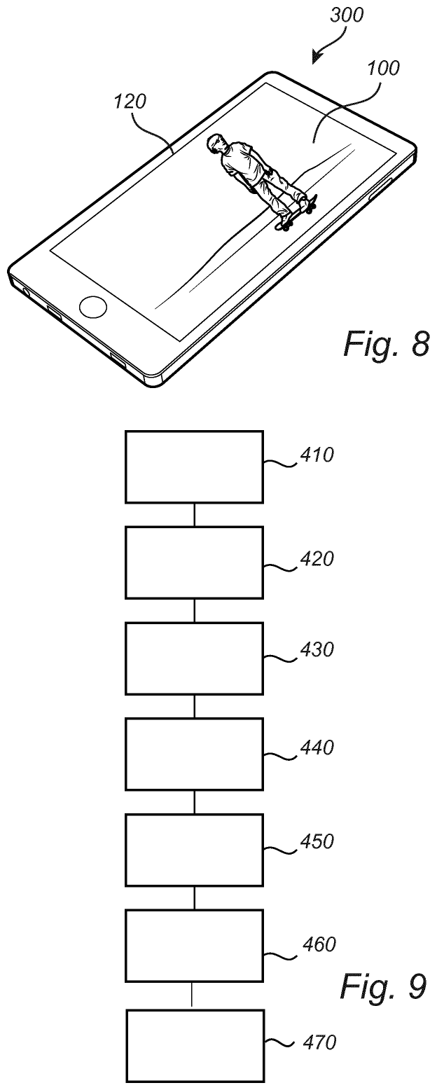

FIG. 8 is a schematic view of a mobile device 300 for video recording comprising a UI 100 according to any one of the preceding embodiments, and further comprising a touch-sensitive screen 120. The mobile device 300 is exemplified as a mobile phone, e.g. a smartphone, but it will be appreciated that the mobile device 300 alternatively may be substantially any device configured for video recording.

FIG. 9 is a flow chart of the method 400 according to the second aspect of the present invention. The method comprises the step of displaying 410 a first view of the video recording. The method 400 further comprises the step of registering 420 at least one marking by a user on the screen of at least one object in the displayed first view of the video recording on the screen on the basis of at least one location marked by the user on the screen. The method 400 further comprises associating 430 the at least one marking with the at least one object, and causing the device to track the marked at least one object. Furthermore, the method comprises defining 440 the tracked at least one object by at least one first boundary, defining 450 a second boundary, wherein at least one of the at least one first boundary is provided within the second boundary, and defining 460 a third boundary and defining a second view of the video recording corresponding to a view of the video recording defined by the third boundary. The method 400 further comprises changing 470 the third boundary such that the third boundary coincides with the second boundary, whereby the second view of the video recording, played in the size of the first view of the video recording, constitutes a zooming of the video recording relative the first view of the video recording.

The person skilled in the art realizes that the present invention by no means is limited to the preferred embodiments described above. On the contrary, many modifications and variations are possible within the scope of the appended claims. For example, it will be appreciated that the figures are merely schematic views of a user interface according to embodiments of the present invention. Hence, any functions and/or elements of the UI 100 such as one or more of the first 270, second 280 and/or third 290 boundaries may have different dimensions, shapes and/or sizes than those depicted and/or described.

### LIST OF EMBODIMENTS

1. A user interface, UI, (100) for zooming of a video recording by a device comprising a screen, the UI being configured to be used in conjunction with the device, wherein the device is configured to display a first view (110) of the video recording on the screen, and to track at least one object on the screen, the UI being configured to:

register at least one marking by a user on the screen of at least one object on the screen in the displayed first view on the basis of at least one location marked by the user on the screen, whereby the UI is provided with user input,

associate the at least one marking with the at least one object, and cause the device to track the marked at least one object,

define the tracked at least one object by at least one first boundary (270),

define a second boundary (280), wherein at least one of the at least one first boundary is provided within the second boundary,

define a third boundary (290) and define a second view of the video recording corresponding to a view of the video recording defined by the third boundary, and

change the third boundary such that the third boundary coincides with the second boundary, whereby the second view of the video recording, played in the size of the first view of the video recording, constitutes a zooming of the video recording relative the first view of the video recording.

2. The user interface according to embodiment 1, further being configured to stabilize at least one of the first view and the second view of the video recording.

3. The user interface according to embodiment 1 or 2, wherein the at least one first boundary is provided within the second boundary, and the second boundary is provided within the third boundary, the user interface further being configured to

decrease the size of the third boundary such that the third boundary coincides with the second boundary, whereby the second view of the video recording, played in the size of the first view of the video recording, constitutes an in-zooming of the video recording relative the first view of the video recording.

4. The user interface according to any one of the preceding embodiments, further being configured to display, on the screen, at least one of the at least one first boundary, the second boundary and the third boundary.

5. The user interface according to embodiment 4, further being configured to display, on the screen, at least one indication (285, 295) of a center portion of at least one of the at least one first boundary, the second boundary and the third boundary.

6. The user interface according to any one of the preceding embodiments, wherein the user interface is a touch-sensitive user interface.

7. The user interface according to embodiment 6, wherein the marking by a user on the screen of at least one object comprises at least one tapping by the user on the screen on the at least one object.

8. The user interface according to embodiment 6 or 7, wherein the marking by a user on the screen of the at least one object comprises an at least partially encircling marking of the at least one object on the screen.

9. The user interface according to any one of the preceding embodiments, further comprising a user input function configured to associate at least one user input with at least one object on the screen, wherein the user input is selected from a group consisting of eye movement, face movement, hand movement and voice, and wherein the user interface is configured to register at least one marking by a user of at least one object based on the user input function.

10. The user interface according to embodiment 9, wherein the user input function is an eye-tracking function configured to associate at least one eye movement of a user with at least one object on the screen, and wherein the user interface is configured to mark at least one object based on the eye-tracking function.

11. The user interface according to any one of the preceding embodiments, further being configured to:

register an unmarking by a user on the screen of at least one of the at least one object.

12. The user interface according to embodiment 11, further being configured to, in case there is no marked at least one object,

increase the size of the third boundary such that the third boundary coincides with the original view, whereby the second view of the video recording, played in the size of the first view of the video recording, constitutes an out-zooming of the video recording relative the second view of the video recording corresponding to a view of the video recording defined by the third boundary of decreased size relative the first view of the video recording.

13. The user interface according to any one of embodiments 6-12, further being configured to:

register at least one gesture by a user on the screen, and to associate the at least one gesture with a change of the second boundary, and to

display, on the screen, the change of the second boundary.

14. The user interface according to embodiment 13, further being configured to:

associate the at least one gesture with a change of size of the second boundary.

15. The user interface of embodiment 14, further being configured to:

register at least one location of a plurality of input points by a user on the screen, and register at least one movement of at least one of the plurality of input points by a user on the screen, and

scale the size of the second boundary based on the at least one location and the at least one movement of the plurality of input points.

16. The user interface according to any one of embodiments 13-15, further being configured to:

associate the at least one gesture with a re-positioning of the second boundary on the screen.

17. The user interface according to embodiment 16, further being configured to:

register the at least one gesture as a scroll gesture by a user on the screen.

18. The user interface according to any one of the preceding embodiments, further being configured to:

estimate a degree of probability that the tracked at least one object is moving out of the first view of the video recording, and, in case the degree of probability exceeds a predetermined probability threshold value, to

generate at least one indicator for a user, and alert the user by the at least one indicator.

19. The user interface according to embodiment 18, further being configured to:

estimate the degree of probability based on an at least one of a location, an estimated velocity and an estimated direction of movement of the at least one object.

20. The user interface according to embodiment 18 or 19, further being configured to:

in case the degree of probability exceeds the predetermined probability threshold value, display at least one visual indicator on the screen as a function of at least one of the location, the estimated velocity and the estimated direction of movement of the at least one object.

21. The user interface according to embodiment 20, wherein the at least one visual indicator comprises at least one arrow.

22. The user interface according to any one of embodiments 18-21, and wherein the device is configured to generate a tactile alert, the user interface further being configured to:

in case the degree of probability exceeds the predetermined probability threshold value, cause the device to a generate a tactile alert.

23. The user interface according to any one of embodiments 18-22, and wherein the device is configured to generate an auditory alert, further being configured to:

in case the degree of probability exceeds the predetermined probability threshold value, cause the device to generate an auditory alert.

24. The user interface according to any one of the preceding embodiments, further being configured to:

display, on a peripheral portion of the screen, the second view of the video recording.

25. The user interface according to any one of the preceding embodiments, further being configured to change the speed of the zooming.

26. A device for video recording, comprising

a screen, and

a user interface according to any one of the preceding embodiments.

27. A mobile device (300), comprising

a device according to embodiment 26, wherein the screen of the device is a touch-sensitive screen.

28. A method (400), for a user interface, UI, (100), for zooming of a video recording by a device comprising a screen, the UI being configured to be used in conjunction with the device, and wherein the device is configured to display the video recording on the screen and to track at least one object on the screen, the method comprising the steps of:

displaying (410) a first view of the video recording,

registering (420) at least one marking by a user on the screen of at least one object on the screen in the displayed first view on the basis of at least one location marked by the user on the screen,

associating (430) the at least one marking with the at least one object, and causing the device to track the marked at least one object,

defining (440) the tracked at least one object by at least one first boundary,

defining (450) a second boundary, wherein at least one of the at least one first boundary is provided within the second boundary,

defining (460) a third boundary and defining a second view of the video recording corresponding to a view of the video recording defined by the third boundary, and

changing (470) the third boundary such that the third boundary coincides with the second boundary, whereby the second view of the video recording, played in the size of the first view of the video recording, constitutes a zooming of the video recording relative the first view of the video recording.

29. A computer program comprising computer readable code for causing a computer to carry out the steps of the method according to embodiment 28 when the computer program is carried out on the computer.

1. A user interface (UI) for zooming of a video recording by a device, the device comprising a screen and configured to display a first view of the video recording on the screen, wherein the UI is configured to be used in conjunction with the device, the UI further being configured to:
register at least one marking by a user on the screen of at least one object on the screen in the displayed first view on the basis of at least one location marked by the user on the screen, whereby the UI is provided with user input,
associate the at least one marking with the at least one object, and cause the device to track the marked at least one object,
define the tracked at least one object by at least one first boundary,
define a second boundary, wherein at least one of the at least one first boundary is provided within the second boundary,
define a third boundary and a second view of the video recording corresponding to a view of the video recording defined by the third boundary, and
change the third boundary such that the third boundary coincides with the second boundary, whereby the second view of the video recording, played in the size of the first view of the video recording, constitutes a zooming of the video recording relative to the first view of the video recording.

2. The user interface according to claim 1, wherein the at least one first boundary is provided within the second boundary, and the second boundary is provided within the third boundary, the user interface further being configured to:
decrease the size of the third boundary such that the third boundary coincides with the second boundary, whereby the second view of the video recording, played in the size of the first view of the video recording, constitutes an in-zooming of the video recording relative to the first view of the video recording.

3. The user interface according to claim 1, further being configured to display, on the screen, at least one of the at least one first boundary, the second boundary and the third boundary.

4. The user interface according to claim 3, further being configured to display, on the screen, at least one indication of a center portion of at least one of the at least one first boundary, the second boundary, or the third boundary.

5. The user interface according to claim 1, wherein the user interface comprises a touch-sensitive user interface.

6. The user interface according to claim 5, wherein the marking by a user on the screen of at least one object comprises at least one tapping by the user on the screen on the at least one object.

7. The user interface according to claim 5, wherein the marking by a user on the screen of the at least one object comprises an at least partially encircling marking of the at least one object on the screen.

8. The user interface according to claim 1, further being configured to:
register an unmarking by a user on the screen of at least one of the at least one object.

9. The user interface according to claim 8, further being configured to, in case there is no marked at least one object,
increase the size of the third boundary such that the third boundary coincides with the first view, whereby the second view of the video recording, played in the size of the first view of the video recording, constitutes an out-zooming of the video recording relative to the second view of the video recording corresponding to a view of the video recording defined by the third boundary of decreased size relative to the first view of the video recording.

10. The user interface according to claim 1, further being configured to:
estimate a degree of probability that the tracked at least one object is moving out of the first view of the video recording, and, in case the degree of probability exceeds a predetermined probability threshold value, to
generate at least one indicator for a user, and alert the user by the at least one indicator.

11. The user interface according to claim 10, further being configured to:
in case the degree of probability exceeds the predetermined probability threshold value, display at least one visual indicator on the screen as a function of at least one of the location, the estimated velocity and the estimated direction of movement of the at least one object.

12. A device comprising
a screen, and
a user interface (UI), wherein the UI is configured to:
register at least one marking by a user on the screen of at least one object on the screen in the displayed first view on the basis of at least one location marked by the user on the screen, whereby the UI is provided with user input,
associate the at least one marking with the at least one object, and cause the device to track the marked at least one object,
define the tracked at least one object by at least one first boundary,
define a second boundary, wherein at least one of the at least one first boundary is provided within the second boundary,
define a third boundary and a second view of the video recording corresponding to a view of the video recording defined by the third boundary, and
change the third boundary such that the third boundary coincides with the second boundary, whereby the second view of the video recording, played in the size of the first view of the video recording, constitutes a zooming of the video recording relative to the first view of the video recording.

13. The device of claim 12, wherein the device is a mobile device and the screen of the device is a touch-sensitive screen.

14. A method of providing a user interface (UI) for zooming of a video recording by a device, the device comprising a screen, the UI configured to be used in conjunction with the device, wherein the method comprises:
displaying a first view of the video recording on the screen,
registering at least one marking by a user on the screen of at least one object on the screen in the displayed first view on the basis of at least one location marked by the user on the screen,
associating the at least one marking with the at least one object, and causing the device to track the marked at least one object,
defining the tracked at least one object by at least one first boundary,
defining a second boundary, wherein at least one of the at least one first boundary is provided within the second boundary,
defining a third boundary and a second view of the video recording corresponding to a view of the video recording defined by the third boundary, and
changing the third boundary such that the third boundary coincides with the second boundary, whereby the second view of the video recording, played in the size of the first view of the video recording, constitutes a zooming of the video recording relative to the first view of the video recording.

13. A computer-readable storage medium comprising instructions for zooming of a video recording by a device, the device comprising a screen, wherein the instructions, when executed by a processor, cause the processor to carry out a method comprising:
displaying a first view of the video recording on the screen,
registering at least one marking by a user on the screen of at least one object on the screen in the displayed first view on the basis of at least one location marked by the user on the screen,
associating the at least one marking with the at least one object, and causing the device to track the marked at least one object,
defining the tracked at least one object by at least one first boundary,
defining a second boundary, wherein at least one of the at least one first boundary is provided within the second boundary,
defining a third boundary and a second view of the video recording corresponding to a view of the video recording defined by the third boundary, and
changing the third boundary such that the third boundary coincides with the second boundary, whereby the second view of the video recording, played in the size of the first view of the video recording, constitutes a zooming of the video recording relative to the first view of the video recording.
